(19) United States
(12) Patent Application Publication
(10) Pub. No.: US 2023/0044512 A1
(43) Pub. Date: Feb. 9, 2023

(54) Business Method of Saving and Treating Water That Creates an Economic Enterprise

(71) Applicant: Jerry Lee Bogard, Stuttgart, AR (US)

(72) Inventor: Jerry Lee Bogard, Stuttgart, AR (US)

(21) Appl. No.: 17/392,292

(22) Filed: Aug. 3, 2021

(51) Int. Cl. G06Q 50/06; G06Q 50/02

(52) U.S. Cl. CPC G06Q 50/06; G06Q 50/02

(57) ABSTRACT

A business method where a water consuming entity such as a farm is currently supplied by depleting underground aquifers would acquire surface water for free delivered via pumps resulting in credits that have commercial value created in two ways: (1) one credit for every 162,925 gallons saved from the aquifer, and (2) an improvement in water quality determined by the reduction of nitrogen, phosphorus and TSS (total soluble solids). The open electronic trading platform of those credits would give real world value to the methods of saving water and improving water quality.

### BACKGROUND OF THE INVENTION

The present invention relates to a financial tool and the method of monetizing the credits created through the treatment of surface water in a closed system allowing for the delivery of that treated water to supplement and reduce and in some cases eliminating the need for water from another source thereby enabling a credit for each of the following: (1) ground water preservation credit, and (2) nutrient reduction credit. These credits that have economic value then can be traded on an open electronic platform. This invention is embodied in a trading platform that uses real world in the field measurements of ground water saved and nutrients reduced. This invention is a trading platform and a method of measuring, creating, and trading a credits on a virtual trading platform that has real world value along with a technological aspect that create a tangible results: (1) saving ground water and (2) reducing nutrients. Another embodiment of those tangible results is better quality water that results in high crop production and the reduction and saving of the soon to be depleted underground aquifer.

### BRIEF SUMMARY OF THE INVENTION

This invention relates more particularly to the exchange of credits on a trading platform generated in two areas: (1) a ground water preservation credit, and (2) a nutrient reduction credit. Currently farmers depend on water supplied by aquifers located under the ground. Numerous engineering reports have shown that certain aquifers are being depleted because of the over pumping. Basically, there are too many straws plunged in the ground with too much horsepower resulting in the man-made depletion of underground aquifers. There are reports and studies showing the groundwater located in the Grand Prairie in Arkansas is the spine of that area. The “spine” is the area that the aquifers are most depleted, and the rate of recharge is slow. This water is used for drinking water and farm irrigation in Arkansas. The Alluvial and the Sparta aquifers are located between the Arkansas and White Rivers. This geographic area consists of several hundred thousand acres of highly productive agriculture lands that also serve as important habit for wintering migratory waterfowl.

One of the technological benefits of this method of saving and treating water is outlined in the second attachment to this specification. The attachment outlines the benefits and improvements of this method of treating and delivering water via pumps, pipes and open water ways is the reduction of nutrients. The present invention distributes surface water to replace the use of ground water in the Sparta aquifer region. As a result of this activity, surface water containing nutrients and suspended solids that would normally be deposited in the Mississippi River and ultimately the Gulf of Mexico are removed from the river water system. Water samples have been taken and tested showing incoming surface water and outgoing water that resulted in several tangible benefits. As more surface water is utilized, more nutrients and solids are removed from the rivers. This activity results in verifiable nutrient and solids reduction that could be used as offset credits for water quality preservation. These credits are then available to be traded for money on an open electronic platform. .

The tangible benefit and real-world value are a water quality offset credit would be tied to a Groundwater Preservation Credit which is one-half acre feet (162,925 gallons). The second credit comes from the nutrient reduction credit measured from the quantity of Nitrogen, Phosphorus and TSS (total soluble solids) removed from that quantity of water. The calculation above will be the quantity in the Water Quality Offset Credit.

Other tangible benefit of this invention results in the preservation of the aquifers, solves the problem of the overuse and depletion of the aquifer, and cleaning up the nutrients in the water before they are transported to the Mississippi River and the Gulf of Mexico. Some other tangible benefits are show below:
Improvement of the Water Quality in the Mississippi River and Gulf of Mexico
Improvement on the Water Quality in the Illinois River
Support for conservation of groundwater in the Sparta Aquifer
Funding of continued infrastructure development to preserve additional ground water and improve additional quantities of surface water in the Mississippi River Watershed
Potential settlement of the Illinois River litigation between Arkansas and Oklahoma over water supply

In order to achieve ground water preservation without disruption of farming or business activity, a large volume surface water supplements are required. This invention of renewable surface water assets provides a stable supply of replacement irrigation or industrial ground water. The closed model design for surface water distribution and crop irrigation supplement, through the monocot plant species, serve to naturally clean up irrigation water prior to discharge for further downstream use. The test results of the water quality show these facts as stated in the attached reports. The credit models for ground water preservation and water quality offset are ready for commercial trading.

### BRIEF DESCRIPTION OF THE DRAWINGS

FIG. 1 is flow chart covering 7 pages of how these credits are generated with real world measures of water pumped and nutrients removed thereby allowing those credits to be commercially traded on an open electronic platform.

### DETAILED DESCRIPTION OF THE INVENTION

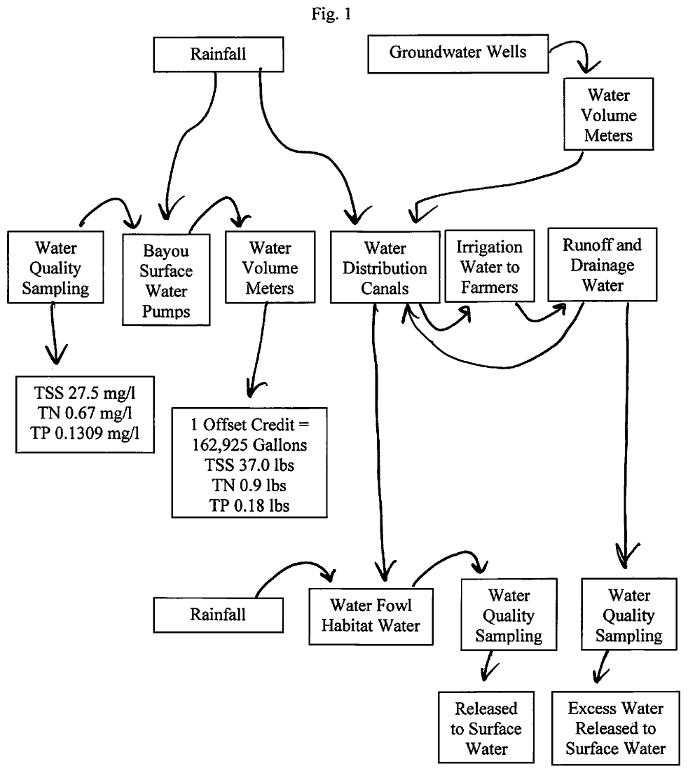

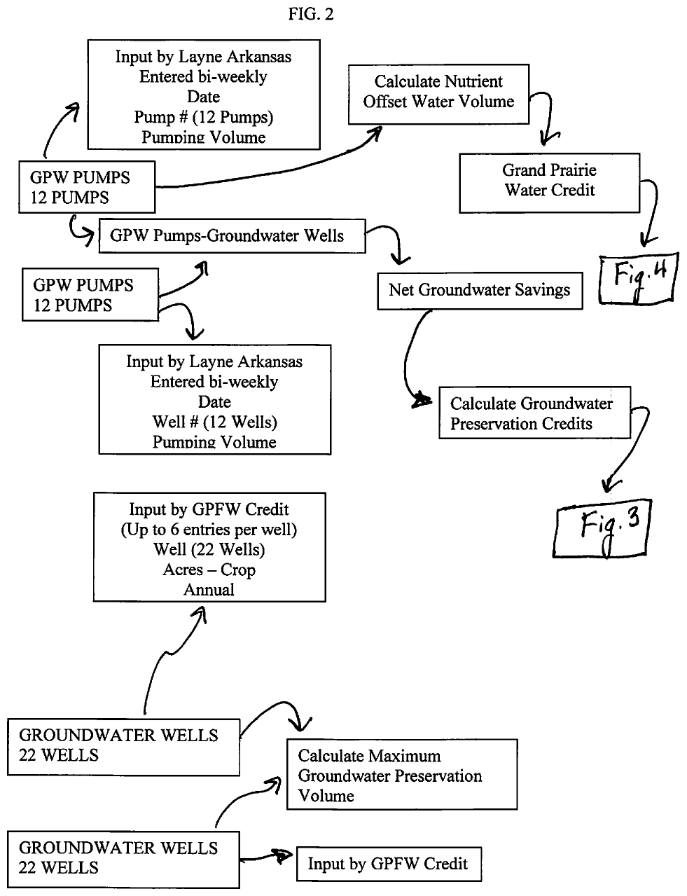

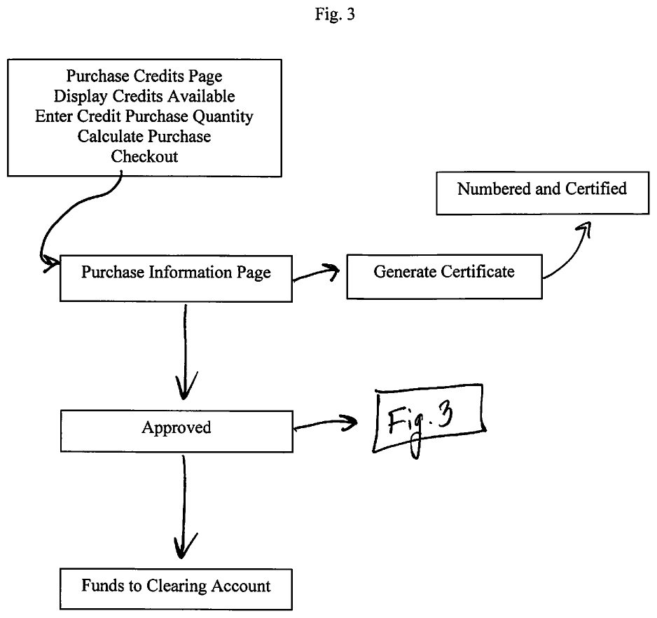

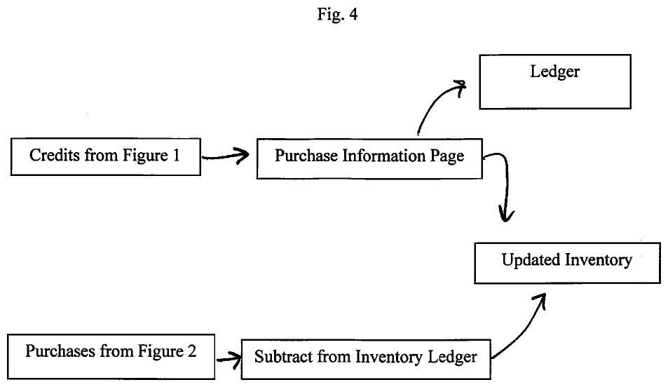

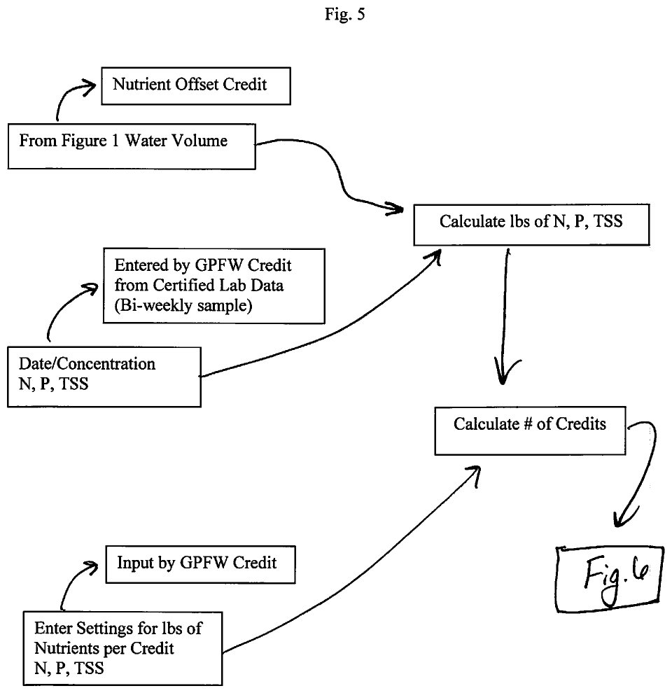

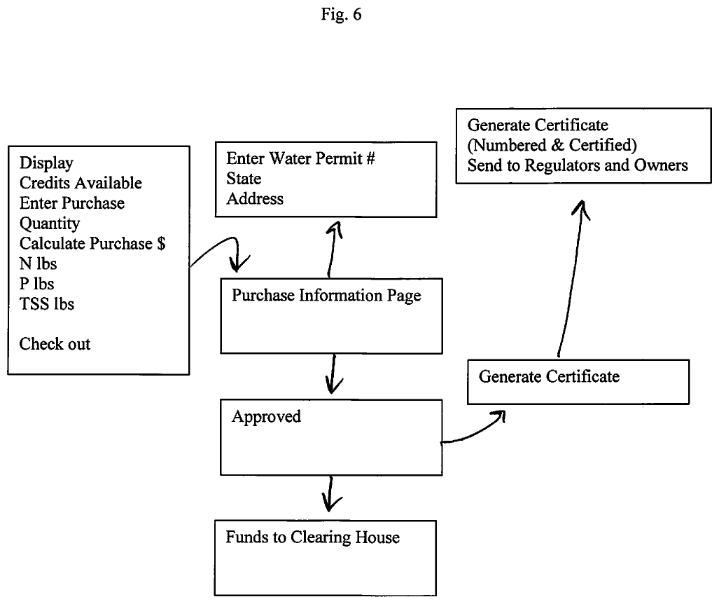

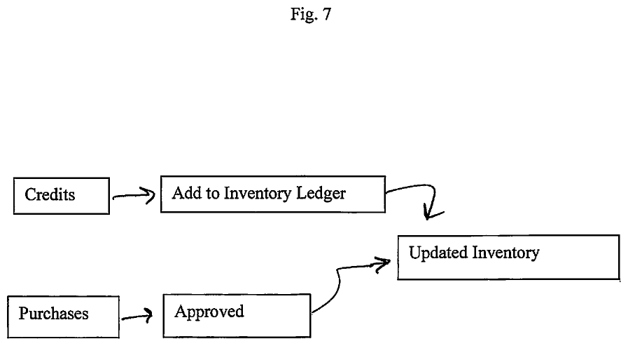

This present invention works by providing a means for the following: (1) reduction of use of ground water from certain aquifers, (2) a reduction of nitrogen, phosphorus and TSS (total soluble solids) in surface being delivered downstream from farming activities, (3) a method of creating offset credits that have commercial value, and a trading platform more specifically described in the flow chart depicted in FIG. 1.

The preferred embodiment of this invention would be a method whereby a farmer would cease to use any underground water and in exchange for the credits created the following two activities (1) ground water preservation credit, and (2) nutrient reduction credit the farmer would get free access to surface water that is pumped to the farmer eliminating the need to use his ground wells. Then those credits created will be traded on an open electronic platform.

As shown in FIG. 1, the measured surface water pumps created two credits.

One credit is generated by the reduction in nitrogen, phosphorus and TSS (total soluble solids) that is confirmed by water quality sampling. The second credit as shown in FIG. 1 is generated by saving and using 162,925 gallons of water. The present invention allows for the reduction of the use of aquifer water and the increase in water quality.

As shown in FIG. 1, rainwater is collected by bayou surface water pumps that are measured and metered. This water is used to replace current farmer water supplied wells that are drilled in the aquifers. This collected water is distributed by water distribution canals for the farmer to use in agricultural activities. In some instances, this water may be recycled via runoff ditches. Excess water is to surface water and can be used as waterfowl habitat.

In operation, a farmer would get water for free in exchange for the credit generated and would cease to use a ground-water wells, thereby preventing the depletion of the aquifers. That credit would then be able to be traded on an open electronic trading platform. The supply and demand of those credits would set the monetary value of those credits via an electronic trading platform.

1. A method for establishing one credit for water saved from an aquifer by a water consuming entity:
establishing one credit for every 162,925 gallons saved from the aquifer;
establishing an improvement in water quality determined by the reduction in nitrogen, phosphorus and TSS (total soluble solids);
reporting method measured by pumps delivering surface water resulting in said credit;
establishing a method to trade those credits on an open trading market wherein those credits have commercial value.

2. The method of claim 1 for establishing the amount of water to be 162,925 gallons of pumped surface water for each credit

3. The method of claim 2, further comprising:
establishing one or more markets to buy and sell said credits generated by method of claim 1

4. The method of claim 1, further comprising the following steps in any order:
saving water from being pumped from an aquifer;
creating credits for every 162,925 gallons pumped from surface water;
improving water quality measured by the reduction in nitrogen, phosphorus and TSS (total soluble solids);
resulting in those credit created to be traded on an open market.
